(19) United States
(12) Patent Application Publication
(10) Pub. No.: US 2012/0240774 A1
(43) Pub. Date: Sep. 27, 2012

(54) INFUSION BARREL STRUCTURE FOR BEVERAGE MAKING DEVICE

(76) Inventor: DANIEL YANG, TAOYUAN COUNTY (TW)

(21) Appl. No.: 13/052,308

(22) Filed: Mar. 21, 2011

(51) Int. Cl. A47J 31/44

(52) U.S. Cl. 99/279

(57) ABSTRACT

An infusion barrel structure for a beverage making device includes a barrel body, a cover and an outflow unit. By dosing the cover to touch a touch switch of the barrel body, the outflow unit is closed. By opening the cover, the touch switch is not pressed by the cover and the outflow unit is opened. The outflow of beverage in the barrel body of the present invention is automatic, without the need of waiting.

### BACKGROUND OF THE INVENTION

1. Field of the Invention

The present invention relates to an infusion barrel structure for a beverage making device, and more particularly to a barrel to outflow beverage automatically.

2. Description of the Prior Art

Taiwan Utility Model No. M312278 discloses an outflow device of a beverage making device, which comprises a base, a filter seat, an adjustment ring and a positioning sleeve. The base has a soaking area and a protruding wall around the outer edge of its bottom. The filter seat is placed in the soaking area of the base. The filter seat has a chamber at an upper section thereof and an adjustment space at a lower section thereof. A filter is provided in the chamber. The filter seat has a plurality of apertures disposed under the filter. The apertures communicate with the adjustment space. A water stopper, a spring and an adjustment valve are provided in the adjustment space. The adjustment ring has an engaging surface at an outer side of an upper end thereof. The positioning sleeve has an annular groove at an inner side of an upper section thereof. An elastic member is provided in the annular groove. The elastic member is against the outer side of the protruding wall of the base to lean against the engaging surface of the adjustment ring. The spring is adjusted to control the time to outflow water.

This outflow device uses the spring to control the time to outflow water. When in use, it is hard to control the time of outflow. Accordingly, the inventor of the present invention has devoted himself based on his many years of practical experiences to solve this problem.

### SUMMARY OF THE INVENTION

The present invention is to solve the problem that a spring is used to supply water automatically and it is hard to control the time of outflow.

According to the present invention, there is provided an infusion barrel structure for a beverage making device comprising a barrel body, a cover and an outflow unit.

The barrel body comprises a touch switch, a control unit and an outlet pipe. The touch switch is electrically connected to the control unit.

The cover is pivotally connected to the barrel body to switch on/off the touch switch.

The outflow unit is connected to the outlet pipe of the barrel body. The outflow unit has an outlet, a through hole and a ball-shaped hole at the junction of the outlet and the through hole. The outlet is perpendicular to the through hole. A ball valve is provided in the ball-shaped hole. The ball valve has a passage therein. The ball valve extends out of the through hole and is connected to a driving member through a driving shaft. The driving member is electrically connected to the control unit of the barrel body. The ball valve is driven by the driving member through the driving shaft for the passage of the ball valve to communicate with the outlet.

Preferably, the driving member is a motor.

The present invention has the following advantages. By dosing the cover to touch the touch switch, the outflow unit is dosed. By opening the cover, the touch switch is not pressed by the cover and the outflow unit is opened. The outflow of beverage in the barrel body of the present invention is automatic, without the need of waiting.

### BRIEF DESCRIPTION OF THE DRAWINGS

FIG. 1 is a perspective view of a preferred embodiment of the present invention;

FIG. 2 is a partial perspective view of the preferred embodiment of the present invention;

FIG. 3 is a cross-sectional view of the preferred embodiment of the present invention to show that the cover is opened and the passage of the outflow unit is open; and

FIG. 4 is a cross-sectional view of the preferred embodiment of the present invention to show that the cover is dosed and the passage of the outflow unit is closed.

### DETAILED DESCRIPTION OF THE PREFERRED EMBODIMENTS

Embodiments of the present invention will now be described, by way of example only, with reference to the accompanying drawings.

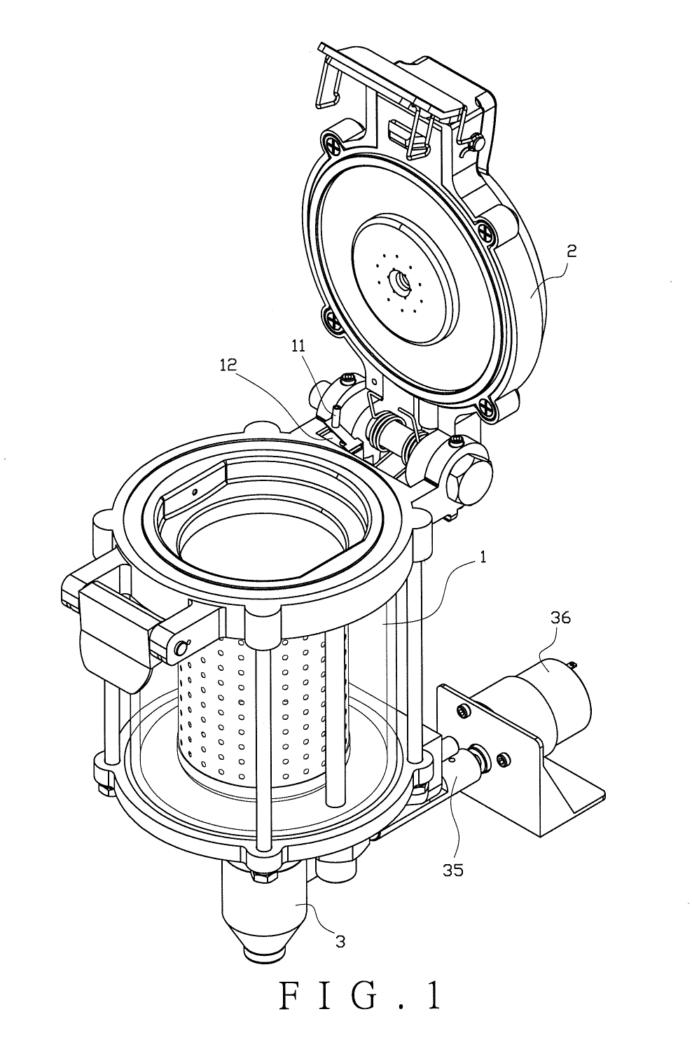

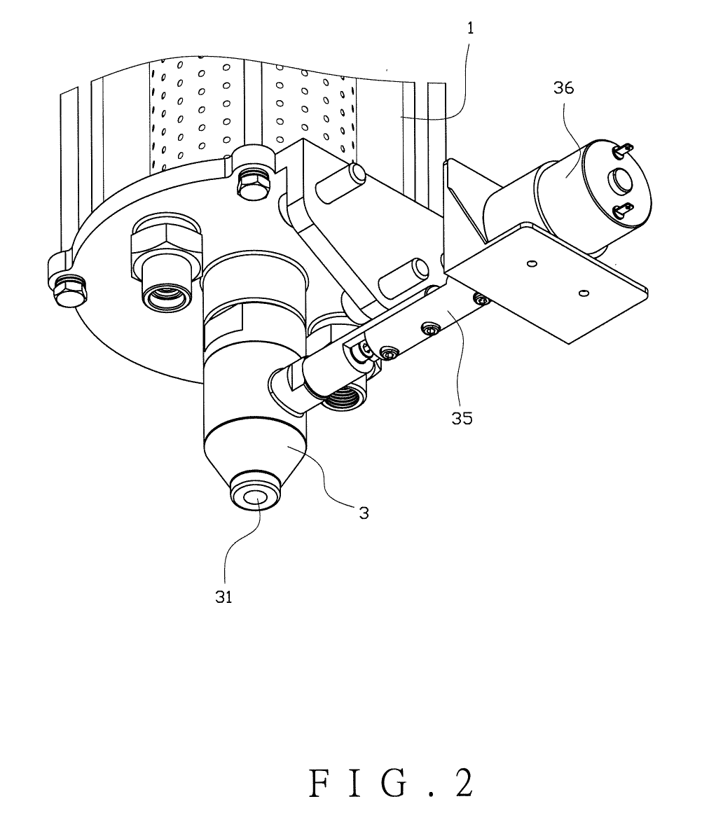

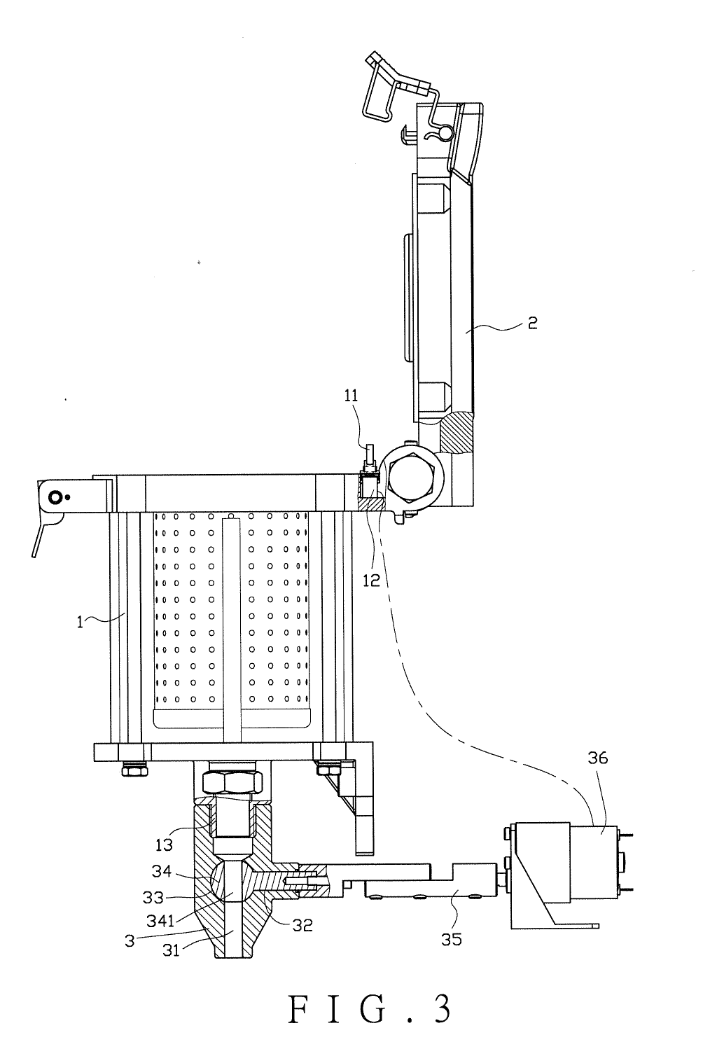

As shown in FIG. 1, FIG. 2 and FIG. 3, the infusion barrel structure for a beverage making device according to a preferred embodiment of the present invention comprises a barrel body (1), a cover (2) and an outflow unit (3).

The barrel body (1) comprises a touch switch (11), a control unit (12) and an outlet pipe (13). The touch switch (11) is electrically connected to the control unit (12).

The cover (2) is pivotally connected to the barrel body (1) to switch on/off the touch switch (11).

The outflow unit (3) is connected to the outlet pipe (13) of the barrel body (1). The outflow unit (3) has an outlet (31), a through hole (32), and a ball-shaped hole (33) at the junction of the outlet (31) and the through hole (32). The outlet (31) is perpendicular to the through hole (32). A ball valve (34) is provided in the ball-shaped hole (33). The ball valve (34) has a passage (341) therein. The ball valve (34) extends out of the through hole (32) and is connected to a driving member (36) through a driving shaft (35). The driving member (36) is a motor. The driving member (36) is electrically connected to the control unit (12) of the barrel body (1). The ball valve (34) is driven by the driving member (36) through the driving shaft (35) for the passage (341) of the ball valve (34) to communicate with the outlet (31).

Referring to FIG. 3, the cover (2) and the barrel body (1) are in an open state, so that the touch control (11) is not pressed and the passage (341) of the ball valve (34) communicates with the outlet (31).

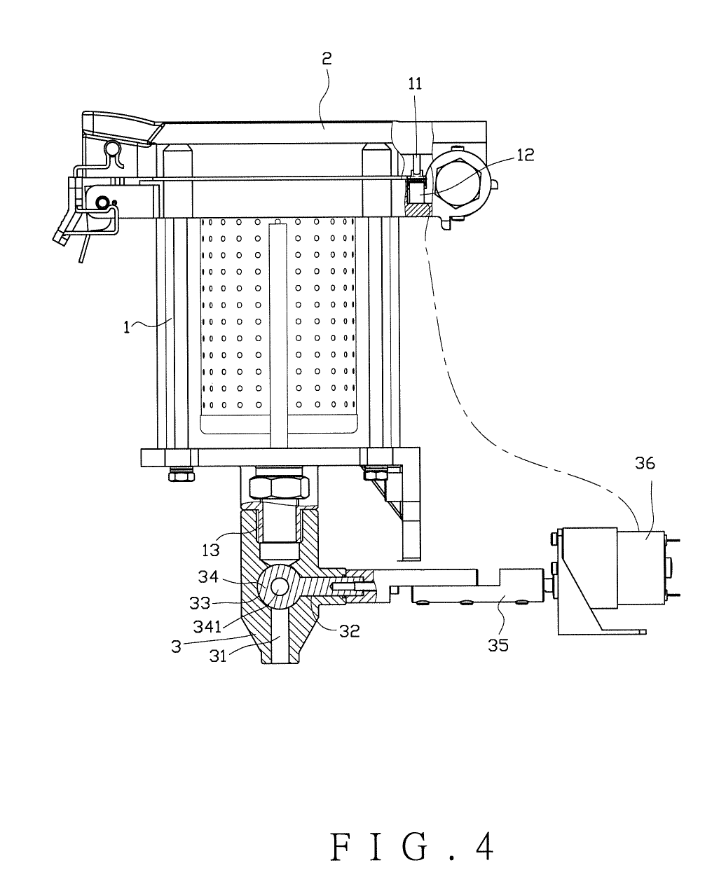

As shown in FIG. 4, when in use, tea leaves or other materials are placed in the barrel body (1) and the cover (2) is dosed. When the barrel body (1) is covered by the cover (2), the cover (2) will touch the touch switch (11) and the touch switch (11) will send a signal to the control unit (12). The control unit (12) sends the signal to the driving member (36) to turn the ball valve (34) through the driving shaft (35), such that the passage (341) of the ball valve (34) doesn't communicate with the outlet (31) and the outlet (31) is closed. Thus, the barrel body (1) is started to pour water or steam (this is a traditional technique and won't be described) for making beverage. After making beverage, the user can open the cover (2) as shown in FIG. 3, and the touch switch (11) not pressed by the cover (2) sends another signal to the control unit (12). The control unit (12) sends the signal to the driving member (36) to turn the ball valve (34) through the driving shaft (35), such that the passage (341) of the ball valve (34) communicates with the outlet (31) and the outlet (31) is opened to flow the beverage in the barrel body (1).

The outflow of beverage in the barrel body (1) of the present invention is automatic. The cover (2) can be dosed for making beverage and opened to flow the beverage, without the need of waiting.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An infusion barrel structure for a beverage making device, comprising:
a barrel body comprising a touch switch, a control unit and an outlet pipe, the touch switch being electrically connected to the control unit;
a cover pivotally connected to the barrel body to switch on/off the touch switch; and
an outflow unit connected to the outlet pipe of the barrel body, the outflow unit having an outlet, a through hole and a ball-shaped hole at the junction of the outlet and the through hole, the outlet being perpendicular to the through hole, a ball valve provided in the ball-shaped hole, the ball valve having a passage therein, the ball valve extending out of the through hole and being connected to a driving member through a driving shaft, the driving member being electrically connected to the control unit of the barrel body, the ball valve being driven by the driving member through the driving shaft for the passage of the ball valve to communicate with the outlet.

2. The infusion barrel structure for a beverage making device as claimed in claim 1, wherein the driving member is a motor.
